(19) United States
(12) Patent Application Publication
(10) Pub. No.: US 2023/0284233 A1
(43) Pub. Date: Sep. 7, 2023

(54) MULTI-TB SCHEDULING FOR SINGLE DCI-BASED MULTI-TRP AND PANEL TRANSMISSION

(71) Applicant: Panasonic Intellectual Property Corporation of America, Torrance, CA (US)

(72) Inventors: Xuan Tuong TRAN, Singapore (SG); Hidetoshi SUZUKI, Kanagawa (JP); Tetsuya YAMAMOTO, Kanagawa (JP); Hongchao LI, Langen (DE); Yoshihiko OGAWA, Kanagawa (JP)

(21) Appl. No.: 18/007,297

(22) PCT Filed: Jun. 5, 2021
(86) PCT No.: PCT/SG2021/050327

§ 371 Date: Jan. 27, 2023

(30) Foreign Application Priority Data
Aug. 6, 2020 (SG) 10202007552X

(51) Int. Cl. H04W 72/23; H04W 72/1268; H04L 1/1812

(52) U.S. Cl. CPC H04W 72/23; H04W 72/1268; H04L 1/1812

(57) ABSTRACT

The present disclosure provides communication apparatuses and communication methods for implementation of Multi-TB Scheduling for Single DCI-Based Multi-TRP/Panel Transmission and Single DCI-based Single TRP/Panel Transmission. The communication apparatuses include a communication apparatus which comprises a receiver, which in operation, receives a single downlink control information (DCI) including scheduling information, the scheduling information indicating radio resources of a plurality of transport blocks (TBs); and circuitry, which in operation, obtains the radio resources of the plurality of TBs based on the scheduling information.

### TECHNICAL FIELD

The following disclosure relates to communication apparatuses and communication methods for implementing Multi-transport block (TB) scheduling for Single Downlink Control Information (DCI)-Based Multi-transmission reception point (TRP) and/or Panel Transmission, as well as single DCI-based single-TRP and/or Panel Transmission which is configured in operation.

### BACKGROUND

New Radio (NR) is a new radio air interface developed by the 3rd Generation Partnership Project (3GPP) for the fifth generation (5G) mobile communications system. With great flexibility, scalability, and efficiency, 5G is expected to address a wide range of use cases including enhanced mobile broadband (eMBB), ultra-reliable low-latency communications (URLLC), and massive machine type communications (mMTC).

One important objective of 5G is to enable connected industries. 5G connectivity can serve as catalyst for next wave of industrial transformation and digitalization, which improve flexibility, enhance productivity and efficiency, reduce maintenance cost, and improve operational safety. Devices in such environment may include for example pressure sensors, humidity sensors, thermometers, motion sensors, accelerometers, actuators, etc. It is desirable to connect these sensors and actuators to 5G networks.

5G connectivity can also serve as catalyst for the next wave smart city innovations. For instance, small devices including wearables such as smart watches, rings, eHealth related devices, medical monitoring devices, reduced capacity (RedCap) devices etc. will benefit from improvements in 5G connectivity.

However, there has been no discussion so far concerning multi-TB scheduling for single DCI-based multi-TRP/Panel transmission and single DCI-based single-TRP and/or Panel transmission which is configured in operation.

There is thus a need for communication apparatuses and methods that can solve the above mentioned issue. Furthermore, other desirable features and characteristics will become apparent from the subsequent detailed description and the appended claims, taken in conjunction with the accompanying drawings and this background of the disclosure.

### SUMMARY

One non-limiting and exemplary embodiment facilitates implementation of multi-TB scheduling for single DCI-based multi-TRP/Panel transmission and single DCI-based single-TRP/Panel transmission in operation. It also includes the implementation case that the single-TRP/Panel transmission mode is dynamically or semi-statically switched to the multi-TRP/Panel transmission mode, and vice versa. The decision of switching is made by gNB based on different criterions. For instance, one of the multiple TRPs/Panels is only activated in operation by using either implicit or explicit indication from gNB, such as a transmission configuration indicator (TCI) state.

In one aspect, the techniques disclosed herein provide a communication apparatus. For example, the communication apparatus can be a subscriber UE, which may be a normal (non-RedCap or Rel-15/16/17) UE, a RedCap UE or other similar types of UE. The communication apparatus comprises a receiver, which in operation, receives a single downlink control information (DCI) including scheduling information, the scheduling information indicating radio resources of a plurality of transport blocks (TBs); and circuitry, which in operation, obtains the radio resources of the plurality of TBs based on the scheduling information.

In another aspect, the techniques disclosed herein provide a communication apparatus. For example, the communication apparatus can be a base station or gNodeB (gNB) which comprises circuitry, which in operation, generates a single DCI including scheduling information, the scheduling information indicating radio resources of a plurality of transport blocks (TBs); and a transmitter, which in operation, transmits the single DCI to a communication apparatus.

In another aspect, the techniques disclosed herein provide a communication method. The communication method comprises receiving a single DCI including scheduling information, the scheduling information indicating radio resources of a plurality of TBs; and obtaining the radio resources for the plurality of TBs based on the scheduling information.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary architecture for a 3GPP NR system.

FIG. 2 is a schematic drawing which shows functional split between NG-RAN and 5GC.

FIG. 3 is a sequence diagram for RRC connection setup/reconfiguration procedures.

FIG. 4 is a schematic drawing showing usage scenarios of Enhanced mobile broadband (eMBB), Massive Machine Type Communications (mMTC) and Ultra Reliable and Low Latency Communications (URLLC).

FIG. 5 is a block diagram showing an exemplary 5G system architecture for a non-roaming scenario.

FIG. 6 shows an example illustration of single DCI-based multi-TRP/Panel transmission.

FIG. 7 shows an example of how TBs are segmented into portions in accordance with various embodiments.

FIG. 8 shows an example of a new Time Domain Resource Assignment (TDRA) table indicating multi-TB scheduling for TRP/Panel transmission in Downlink (DL) Physical Downlink Shared Channel (PDSCH) in accordance with an embodiment 1.

FIG. 9 shows a user equipment (UE) flowchart for indicating Time Domain Resource Assignment (TDRA) for multi-TB scheduling for multi-TRP/Panel operation in accordance with an embodiment 1 when multiple TCI states are indicated by gNB.

FIG. 9 also shows that when one TCI state is indicated by gNB, a single TRP/Panel is activated in operation so that the TDRA for multi-TB scheduling is now used for the single TRP/Panel operation.

FIG. 10 shows an enhanced PDSCH-TimeDomainResourceAllocation information element (IE) indicating configuration information in accordance with an embodiment 1.

FIG. 11 shows an example table of time-domain resource sets of 4 portions for TRP #1 and TRP #2 in accordance with an embodiment 1.

FIG. 12 shows an example illustration of multi-TB scheduling for single DCI-based multi-TRP/Panel transmission in TDM in accordance with an embodiment 1.

FIG. 13 shows an example of a PDSCH-TimeDomainResourceAllocation IE is enhanced to indicate configuration information for multi-TB scheduling with repetition in accordance with an embodiment 2.

FIG. 14 shows an example of time-domain resource sets of 4 portions for TRP #1 and TRP #2 in accordance with an embodiment 2.

FIG. 15 shows an example illustration of multi-TB scheduling with repetition for single DCI-based multi-TRP/Panel transmission in accordance with an embodiment 2.

FIG. 16 shows an example illustration of multi-TB scheduling with repetition for single DCI-based multi-TRP/Panel transmission in frequency-division multiplexing (FDM) scheme in accordance with an embodiment 4.

FIG. 17 shows an example illustration of multi-TB scheduling for a scenario of cross-carrier scheduling in multiple transmission intervals in accordance with an embodiment 4.

FIG. 18 shows a UE flowchart for a transmission configuration indicator (TCI) state-based retransmission in accordance with an embodiment 7. FIG. 18 also shows that when one TCI state is indicated by gNB, a single TRP/Panel is activated in operation.

FIG. 19 shows a flow diagram of a communication method for implementation of multi-TB scheduling for single DCI-based multi-TRP/Panel transmission in accordance with various embodiments.

FIG. 20 shows a schematic example of a communication apparatus that can be used for implementation of multi-TB scheduling for single DCI-based multi-TRP/Panel transmission in accordance with various embodiments.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

### 5G NR System Architecture and Protocol Stacks

3GPP has been working at the next release for the 5th generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of smartphones.

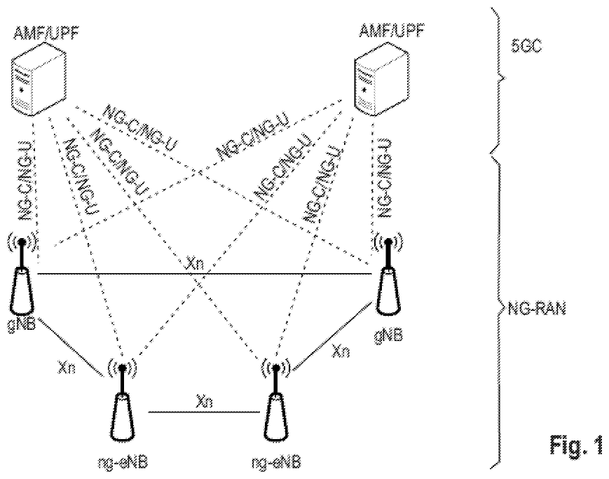

Among other things, the overall system architecture assumes an NG-RAN (Next Generation—Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 1 (see e.g. 3GPP TS 38.300 v15.6.0, section 4).

The user plane protocol stack for NR (see e.g. 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH (Physical Uplink Shared Channel) and PUCCH (Physical Uplink Control Channel) for uplink and PDSCH (Physical Downlink Shared Channel), PDCCH (Physical Downlink Control Channel) and PBCH (Physical Broadcast Channel) for downlink.

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v15.6.0).

### 5G NR Functional Split Between NG-RAN and 5GC

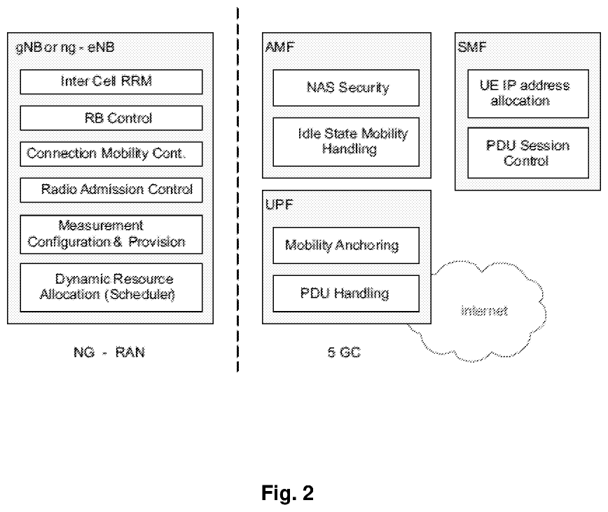

FIG. 2 illustrates functional split between NG-RAN and 5GC. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signalling termination;
NAS signalling security;
Access Stratum, AS, Security control;
Inter Core Network, CN, node signalling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

### RRC Connection Setup and Reconfiguration Procedures

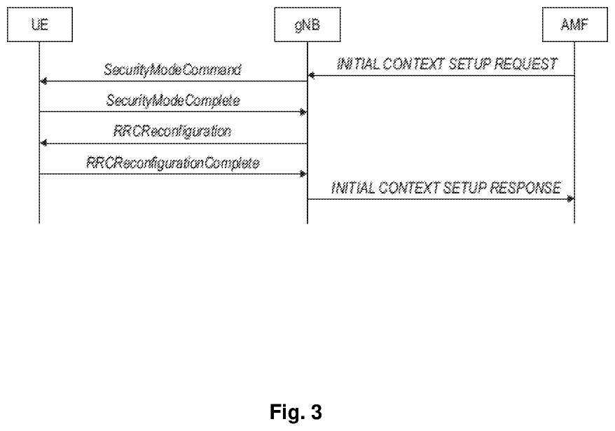

FIG. 3 illustrates some interactions between a UE, gNB, and AMF (an 5GC entity) in the context of a transition of the UE from RRC_IDLE to RRC_CONNECTED for the NAS part (see TS 38.300 v15.6.0). RRC is a higher layer signaling (protocol) used for UE and gNB configuration. In particular, this transition involves that the AMF prepares the UE context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signalling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

In the present disclosure, thus, an entity (for example AMF, SMF, etc.) of a 5th Generation Core (5GC) is provided that comprises control circuitry which, in operation, establishes a Next Generation (NG) connection with a gNodeB, and a transmitter which, in operation, transmits an initial context setup message, via the NG connection, to the gNodeB to cause a signaling radio bearer setup between the gNodeB and a user equipment (UE). In particular, the gNodeB transmits a Radio Resource Control, RRC, signaling containing a resource allocation configuration information element to the UE via the signaling radio bearer. The UE then performs an uplink transmission or a downlink reception based on the resource allocation configuration.

### Usage Scenarios of IMT for 2020 and Beyond

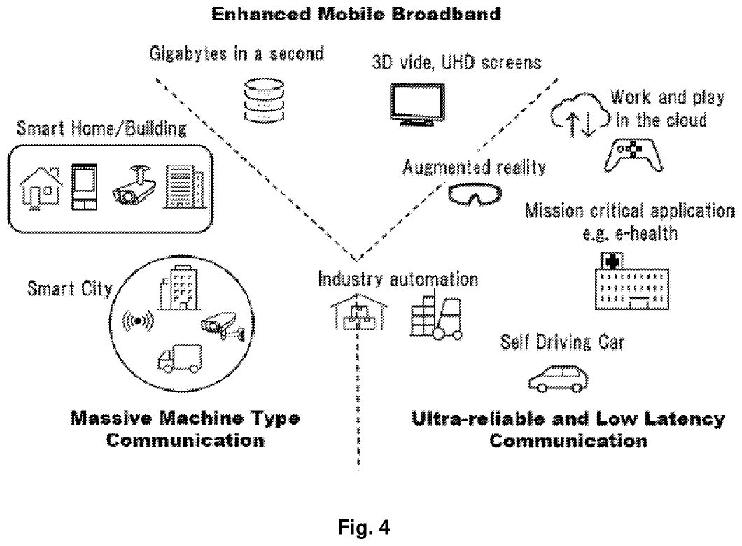

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact downlink control information (DCI) formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non-slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10-6 level), higher availability, packet sizes of up to 256 bytes, time synchronization down to the order of a few μs where the value can be one or a few μs depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

### QoS Control

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU

Session, and additional DRB(s) for QoS flow(s) of that PDU session can be subsequently configured (it is up to NG-RAN when to do so), e.g. as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

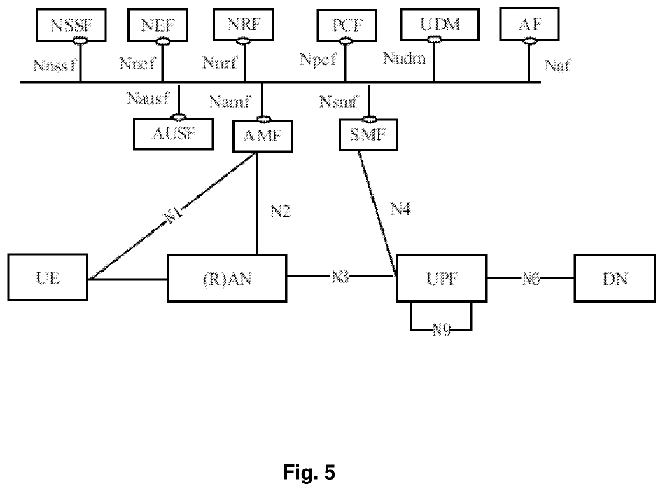

FIG. 5 illustrates a 5G NR non-roaming reference architecture (see TS 23.501 v16.1.0, section 4.23). An Application Function (AF), e.g. an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN), e.g. operator services, Internet access or 3rd party services. All of or a part of the core network functions and the application services may be deployed and running on cloud computing environments.

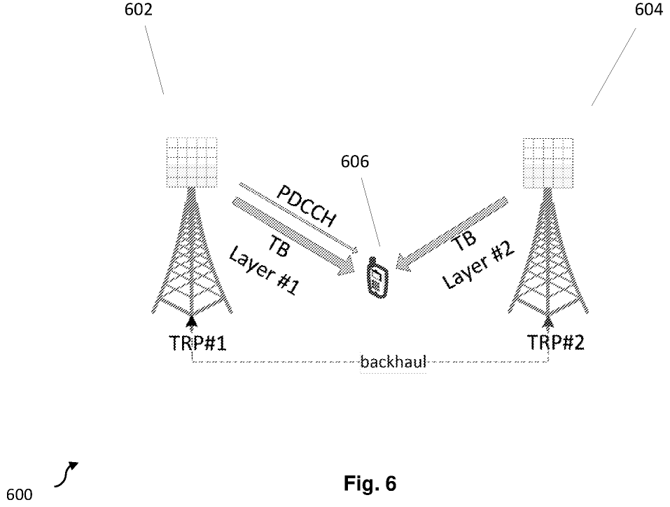

Single DCI-based Multi-transmission reception point (Multi-TRP) or Panel transmission is supported in NR. A gNB can schedule a transport block (TB) in DL from multiple TRPs, where the TB from different TRPs are transmitted in different layers as shown in illustration 600 of FIG. 6. For example, a TB is transmitted from a TRP #1 602 via PDCCH in a Layer #1 to a communication apparatus 606 while a same TB is transmitted from a TRP #2 604 in a Layer #2 to the communication apparatus 606. TCI state in DCI indicates the associated TRP or Panel of a TB. A single DCI can schedule only a single TB. The repetition of single TB in DL from multiple TRPs using a single DCI is also supported. Further, multiple TBs in UL scheduled by a single DCI is supported in NR-U for single TRP arrangements, and multiple TBs in DL or UL scheduled by a single DCI is supported in LTE enhanced machine-type communication/narrowband Internet of Things (eMTC/NB-IoT) for a single TRP.

As DCI-only slots without any TB scheduling in DL or UL consumes the UE power, it is desirable to provide solutions to address this issue. For example, a gNB can schedule more than one TB (i.e., multi-TB scheduling) by a single DCI to reduce DCI-only slots and also reduce the UE power consumption. Further, this multi-TB scheduling by a single DCI should be applied to multi-TRP/Panel scenario to have multi-TRP/Panel gain. It will be appreciated that “multiple TBs” may be used inter-changeably with “plurality of TBs”.

According to an embodiment 1, a DCI indicates more than one TCI states, wherein each of the indicated TCI states corresponds to an activation of one TRP or panel; and it schedules DL radio resource for multiple TBs by indicating an entry in a time-domain resource assignment (TDRA) table. In the entry, each of the multiple TBs is defined by start and length indicator value (SLIV) and its association with one of the indicated TCI states. Alternatively, instead of start and length indicator value (SLIV), start symbol and allocation length can be used, or slot offset can be used. Further, instead of an indicated TCI state, a TRP or a panel can be used. It will be appreciated that TCI state and TRP can be inter-changeably used in the embodiments and examples described, herein for an example, TCI state #1 will correspond to TRP #1, TCI state #2 will correspond to TRP #2, and so on.

In addition, a DCI indicates a TCI state in a codepoint which corresponds to an activation of a single TRP or panel. In this manner, the single-TRP/Panel transmission mode is dynamically switched to the multi-TRP/Panel transmission mode, and vice versa. The decision of switching is made by gNB and it is signalled to a UE based on number of TCI states indicated in the DCI. For instance, when a TCI state is indicated in the DCI, either TRP #1 or TRP #2 is activated in operation.

According to an embodiment 1, a DCI indicates one TCI state corresponding to an activation of one TRP or panel, so that it schedules the radio resources of the plurality of TBs that are associated with the indicated TCI state.

In a variation 1.0 of the embodiment 1, an association of each of multiple TBs with one of indicated TCI states is indicated in either an explicit or implicit manner. In an explicit manner, this association is indicated by using at least DCI, MAC control element (CE) or RRC message. In an implicit manner, this association is indicated by a pre-configured rule. For example, a TB with even index is associated with TCI state with even index, while a TB with odd index is associated with TCI state with odd index. In another example, this association is defined based on a linkage between the indicated TCI state for each of multiple TBs with its scheduled DL or UL radio resource parameters including at least the SLIV, start symbol, allocation length, or slot offset.

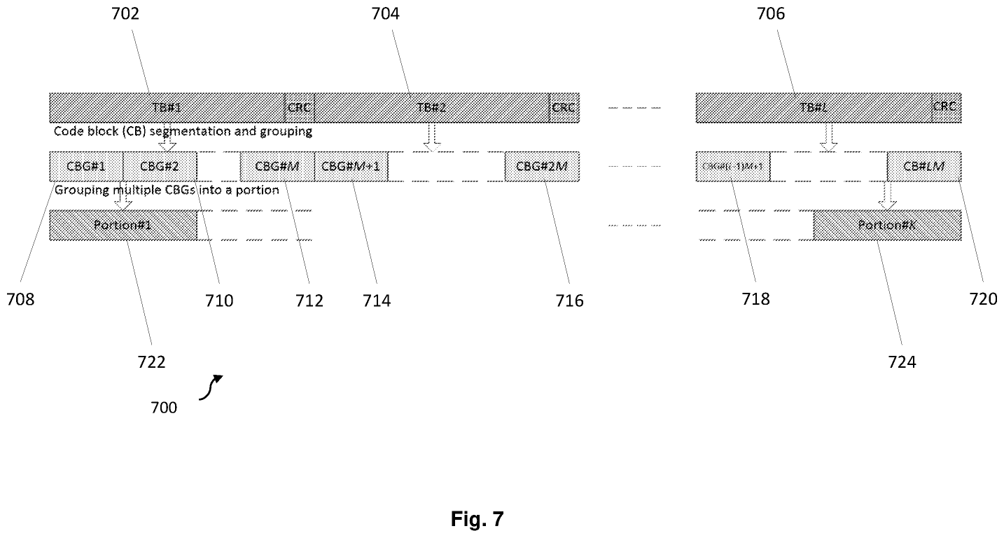

In a variation 1.1 of the embodiment 1, multiple TBs L are segmented into plurality K portions, where the size of each portion can be configurable. Instead of “each of multiple TBs” in embodiment 1, each of a plurality of portions is used for variation 1.1. An example of this segmentation is shown in illustration 700 of FIG. 7. L TBs (TB #1 702, TB #2 704 up to TB #L 706) are segmented into K portions (portion #1 722 up to portion #K 724). The TBs comprise a plurality of code-block-groups (CBGs) CBG #1 708, CBG #2 710, CBG #M 712, CBG #M+1 714, CBG #2M 716, CBG #(L+1)M+1 718 up to CBG #LM 720. Each portion can be made up of different numbers of CBGs and can therefore vary in size from one another. For example, portion #1 722 comprises CBG #1 708 and CBG #2 710 i.e. a size of 2 CBGs. However, portion #K 724 may not necessarily comprise the same number of CBGs as portion #1 722. Further, each portion can include one or plurality of CBGs from a TB or different TBs. Each size of the portions can be either less, equal, or greater than a size of the TB. The number of CBGs in each portion can be the same or different among the portions. It will be appreciated that “plurality of portions” may be used inter-changeably with “multiple portions”.

In a variation 1.1a, each of the a plurality of portions includes one or more TBs, i.e., TB group per TRP/Panel. In another variation 1.1b, the size of each portion is configured based on quality of communication link between its associated TCI state (TRP) and UE. For example, more CBGs can be configured to comprise a portion and/or more numbers of portions that are associated with a TCI state in a good channel condition, or vice versa. This advantageously enables adaption to channel conditions to improve system performance in term of spectral and energy efficiency.

In a variation 1.2, each of plurality of portions includes one or more TBs from the plurality of TBs, and two or more TBs relating to different TRPs in the plurality of TBs may be associated with different portions. Further, two or more TBs relating to a same TRP in the plurality of TBs may be associated with one portion.

In a variation 1.3 of the embodiment 1, a new TDRA table is created by adding new entries to enhance PDSCH-TimeDomainResourceAllocation information element (IE) to support multi-TB scheduling. A one bit-field of a single DCI (i.e. TDRA field) is used to indicate the configuration information of each portion. In a variation 1.4, for each portion, a TDRA entry additionally includes one or a combination of the following: a portion index (Portion #k), a slot offset for the corresponding portion transmission after the scheduling DCI slot offset (K₀_{ₖ}), an association of this portion with different spatial information, a redundancy version (RV) and a Mapping type. Furthermore, the slot offset for the corresponding portion transmission is also determined based on a gap or an interval between the corresponding portion transmission and one of the other portion transmissions. In this manner, multiple portions can be transmitted in consecutive or non-consecutive slots, as well as they can or cannot be transmitted continuously in time domain.

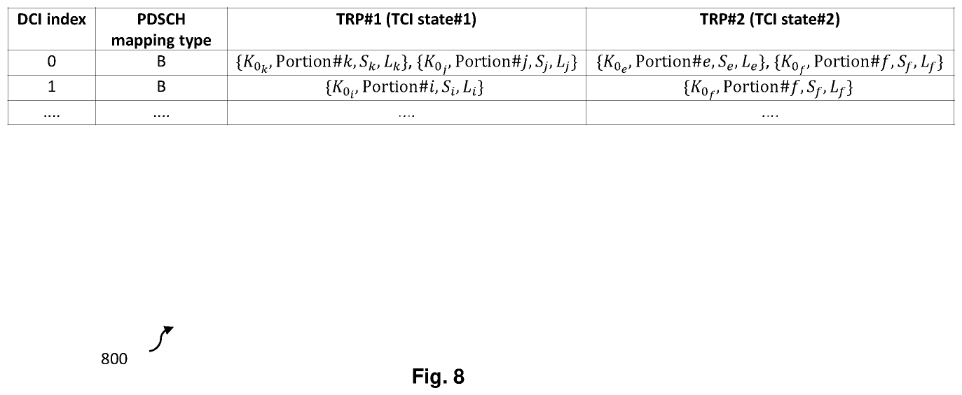

An example of a new TDRA table 800 is shown in FIG. 8. For example, referring to DCI index 0, PDSCH mapping type is indicated as “B”. There are two TRPs/TCI states, namely TRP #1(TCI state #1) and TRP #2(TCI state #2). TRP #1(TCI state #1) has two transmissions, indicated by time domain entries {K₀_{ₖ}, Portion #k, Sₖ, Lₖ} and {K₀_{ⱼ}, Portion #j, Sⱼ, Lⱼ}, while TRP #2(TCI state #2) also has two transmissions indicated by time domain entries {K₀_{ₑ}, Portion #e, Sₑ, Lₑ} and {K₀_{_{f}}, Portion #f, S_{f}, L_{f}}. Furthermore, K₀_{ⱼ} can also be determined as K₀_{ₖ}+w, where w is a gap or an interval between the transmission of Portion #j and the transmission of Portion #k. As per variation 1.3, each time domain entry includes one or a combination of a portion index (Portion #k), a slot offset for the corresponding portion transmission after the scheduling DCI slot offset (K₀_{ₖ}), an association of this portion with different spatial information, a redundancy version (RV) and a Mapping type.

In a variation 1.5, the plurality of portions are transmitted or received in a same slot and/or a different slot (i.e., cross-slot scheduling) with the single DCI based on their own slot offsets. In a variation 1.6, the plurality of portions are transmitted or received in a same slot as the single DCI when the slot offsets are 0 (i.e., same-slot scheduling).

In a variation 1.7, for each TCI state, only one of a plurality of associated portions is configured with a reference signal (RS) to derive spatial information, while the remaining portions are configured as Quasi Co Located (QCL-ed) with this RS (i.e., these remaining portions are not configured with dedicated RSs). A benefit of implementing variation 1.7 is that system overhead over the air interface is reduced.

In a variation 1.8, for each TCI state, a default spatial information is configured for one or more associated portions implicitly or explicitly. A benefit of implementing variation 1.8 is that UE can use a default spatial information for channel estimation or precoding when an indicated spatial information is not available.

It may be assumed that the size of portions is less than a TB or a TB includes some portions. When each of the plurality of portions is associated with a spatial information or each of these portions is assigned to be transmitted from different TRP, a TB has multiple spatial information, i.e., the plurality of CBGs/portions of this TB have different spatial information. Spatial information (including QCL Type A, B, C, or D) from different TRP to a UE is different from each other.

Accordingly, under embodiment 1, a UE may operate in the following manner. The UE is signaled scheduling information indicating DL/UL radio resource for each of a plurality of portions by TDRA table. For each of the plurality of portions, the UE uses one-bit TDRA field in the scheduling DCI to determine explicitly or implicitly:
Time-domain resource set for each portion: Each time-domain resource set {K₀_{ₖ}, Portion #k, Sₖ, Lₖ} is mapped one-to-one to each portion to derive the values of starting symbol and length within a slot with offset from the DCI
Association of each portion to one of the indicated TCI states: Based on the location of time-domain resource set of each portion on which column it is assigned, i.e., one-to-one mapping, “TCI state #1” or “TCI state #2”. For example, as DCI index is 0 in Table 800 of FIG. 8, {K₀_{ₖ}, Portion #k, Sₖ, Lₖ} is assigned to be associated with TRP #1 (TCI state #1).

Number of transmissions to be scheduled from an indicated TCI state: It is implicitly derived by the number of time-domain resource sets within a given group associated with the indicated TCI state. For example, as DCI index is 0 in Table 800 of FIG. 8, TCI state #1 has a group of two sets {K₀_{ₖ}, Portion #k, Sₖ, Lₖ} and {K₀_{ⱼ}, Portion #j, Sⱼ, Lⱼ}, so it has two transmissions.

It will be appreciated that this is only an example and there can be number of other possibilities in term of number/order of TRPs, time-domain resource sets, groups depending on the UE capability and/or gNB implementation.

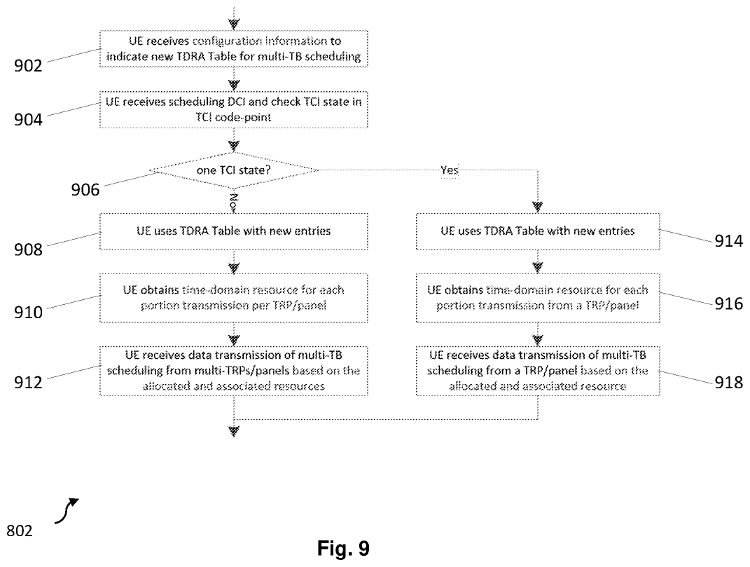

Based on the derived information and indicated TCI states, the UE decodes or transmits different data from multiple TBs mapped on radio resources for the corresponding PDSCH receptions or PUSCH transmissions, respectively. FIG. 9 shows a user equipment (UE) flowchart 900 for time division multiplexing (TDM) in accordance with embodiment 1. At step 902, a UE receives configuration information to indicate new TDRA table for multi-TB scheduling. At step 904, the UE receives scheduling DCI and checks TCI state in TCI code-point. At step 906, it is determined whether there is only one TCI state. If it is determined to be the case, the process proceeds to step 914 where the UE uses the TDRA table with new entries. At step 916, the UE obtains time-domain resource for each portion transmission from a TRP/Panel. At step 918, the UE receives data transmission of multi-TB scheduling from a TRP/Panel based on the allocated and associated resource, and the process ends. If it is determined at step 906 that there are more than one TCI state, the process proceeds to step 908 where the UE uses the TDRA table with new entries. At step 910, the UE obtains time-domain resource for each portion transmission per TRP/Panel. At step 912, the UE receives data transmission of multi-TB scheduling from multi-TRPs/Panels based on the allocated and associated resources, and the process ends.

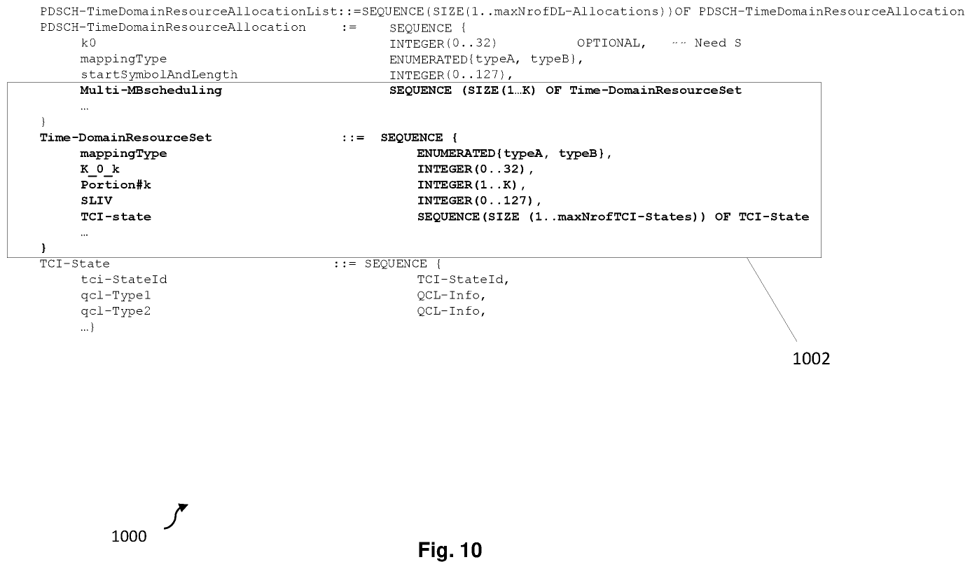

In an example for variation 1.3, PDSCH-TimeDomainResourceAllocation is enhanced to indicate configuration information for embodiment 1. Referring to FIG. 10 which shows an enhanced PDSCH-TimeDomainResourceAllocation information element (IE) 1000 indicating configuration information in accordance with embodiment 1, new entry Multi-MBscheduling 1002 is proposed to indicate support of multi-TB scheduling, where SLIV is used to derive Sₖ and Lₖ, maxNrofTCl-States is the maximum number of configured TCI states, and TCI-StateId is the index of TCI state associated with the corresponding indicated TRP/Panel in TCI code-point. One bit-field of a single DCI is used to indicate the index of Time-DomainResourceSet for each portion transmission.

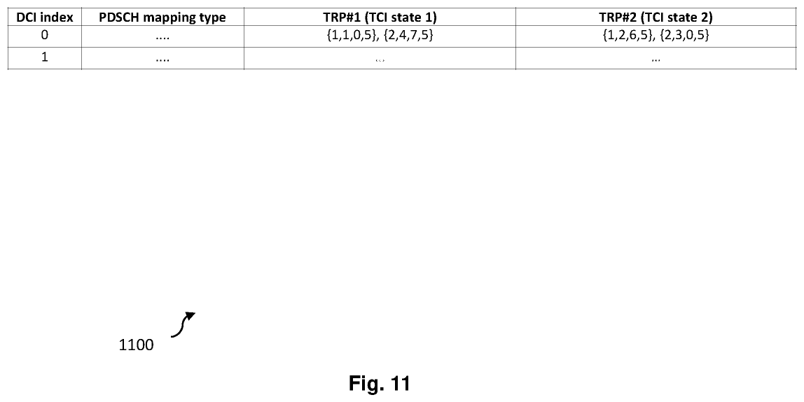

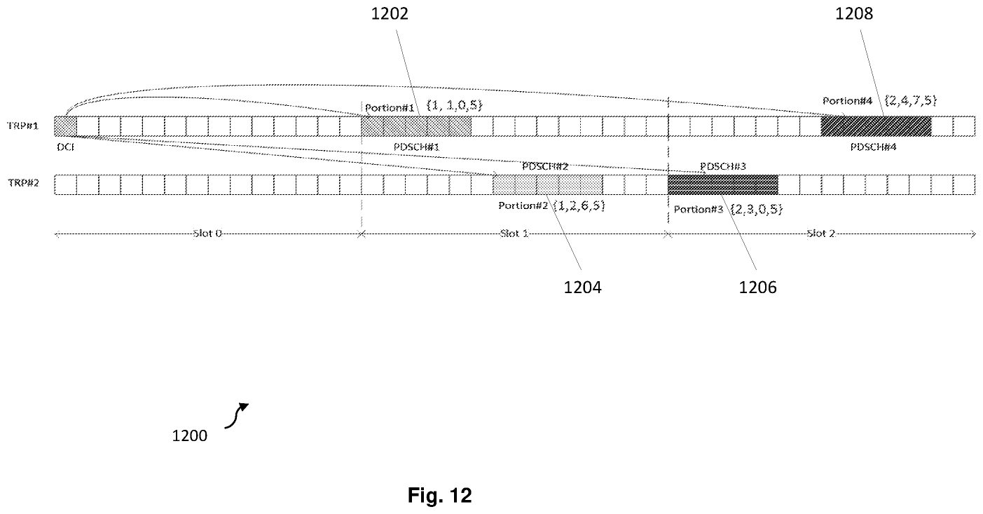

FIG. 11 shows an example table 1100 of time-domain resource sets of 4 portions for a TRP #1 and a TRP #2 in accordance with an example for variation 1.1 of embodiment 1. FIG. 12 shows an example illustration 1200 of multi-TB scheduling for single DCI-based multi-TRP/Panel transmission in TDM in accordance with the same example. Two TBs, each of which has 4 CBGs, are segmented to 4 portions. Each portion comprises two CBGs. These time-domain resource sets of 4 portions for TRP #1 and TRP #2 are shown in table 1100 and illustration 1200. Referring to table 1100, for DCI index 0, TRP #1(TCI state #1) has two portions (a portion #1 {1,1,0,5} and a portion #4 {2,4,7,5}) and TRP #2(TCI state #2) has two portions (a portion #2 {1,2,6,5} and a portion #3 {2,3,0,5}). If DCI index 0 of Table 1100 is indicated to a UE, the UE derives the time-domain resource sets and associations with TRPs from the table.

Time-domain resource for each portion assignment is defined as follows. For portion #1 {1,1,0,5}, the slot offset is 1 slot after the scheduling DCI, portion index is 1, starting symbol is 0 and length is 5 in slot 1. For portion #2 {1,2,6,5}, the slot offset is 1 slot after the scheduling DCI, starting symbol is 6 and length is 5 in slot 1. For portion #3 {1,1,0,5}, the slot offset is 2 slot after the scheduling DCI, starting symbol is 0 and length is 5 in slot 2. For portion #4 {2,4,7,5}, the slot offset is 2 slot after the scheduling DCI, starting symbol is 7 and length is 5 in slot 2. In terms of association of each portion to one of the indicated TRPs/Panels, Portions #1 and #4 are transmitted from TRP #1, while portions #2 and #3 are transmitted from TRP #2. Further, the actual numbers of transmissions from TRP #1 and TRP #2 are 2. Therefore, referring to FIG. 12, the transmission of portion #1 is shown at 1202, the transmission of portion #2 is shown at 1204, the transmission of portion #3 is shown at 1206 and the transmission of portion #4 is shown at 1208.

According to an embodiment 2, instead of “multiple TBs” in embodiment 1, multiple repeated TBs can be used. Each of the multiple TBs is associated with one of the indicated TCI state. Alternatively, each of a repetition of multiple TBs is associated with one of the indicated TCI state. Advantageously, this arrangement supports coverage enhancement for non-RedCap UEs and coverage recovery for RedCap UEs. Further, flexible configuration of repetition of each of multiple TBs is possible i.e., each TB can be configured to have a different number of repetitions.

In a variation 2.1 of embodiment 2, repetition of each portion can be characterized by a higher layer parameter, e.g., Rₖ. Rₖ can be configured as a symbolic value, e.g., Rₖ=0, or absent to indicate an initial transmission of the kth portion. The order of a repetition of the kth portion is configured as a predefined rule as an ascending order rule. For example, {K₀_{ₖ}, Portion #k, Sₖ, Lₖ, Rₖ=a} means the a^{th} repetition of the Portion #k, where the values of slot offset can be different from that of the initial transmission of the Portion #k. In another example, for a portion #1 {1,1,0,5,0}, the slot offset is 1 slot from the scheduling DCI. For a 2^{nd} repetition of portion #1 {2,1,0,5,2}, the slot offset is 2 slot from the scheduling DCI.

In a variation 2.2 of embodiment 2, an association of repetition of each portion to one of the indicated TCI states (or TRPs/Panels) and/or spatial information can be either same or different than that of initial transmission of this portion. In a variation 2.3, a different RV can be applied for a repetition of each portion. In a variation 2.4, an initial transmission of multi-TB scheduling is designed for an indicated TRP with the scheduling DCI, named as a primary TRP, while repetitions of multi-TB scheduling are only used in the remaining TRPs. A benefit for implementing variation 2.4 is to provide diversity gain from multi-path transmissions. In a variation 2.5, interleaving pattern can be applied for the contents of all the portions and their own repetitions to enable dynamic multi-TB scheduling with repetition scheduled by a DCI. This interleaving pattern can be based on a preconfigured rule and indicated to the UE. For example, the interleaving pattern is indicated implicitly by a pre-configured rule or explicitly by at least DCI, MACE or RRC signalling. Advantageously, this minimises the fading effect on data estimation.

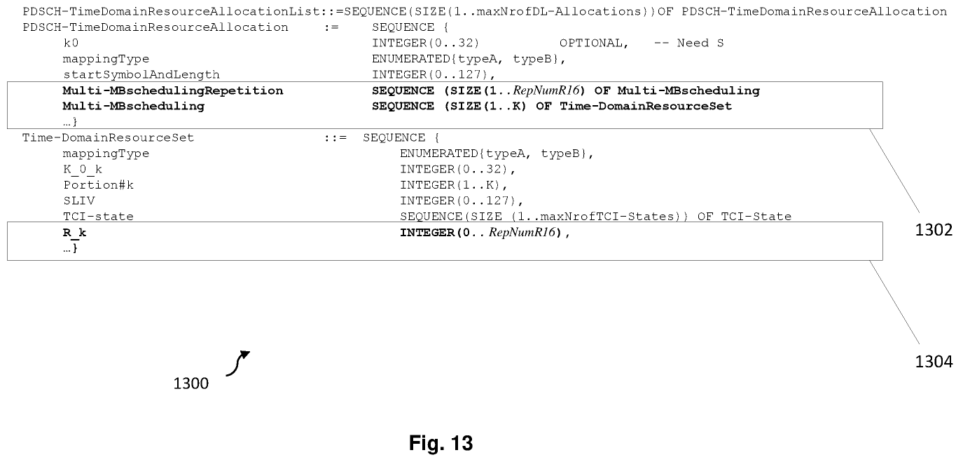

In an example for variations 2.1 and 2.2, PDSCH-TimeDomainResourceAllocation IE is enhanced to indicate configuration information for multi-TB scheduling with repetition by adding repetition information. Referring to PDSCH-TimeDomainResourceAllocation IE 1300 as shown in FIG. 13, new entries for repetition information are shown in portions 1302 and 1304.

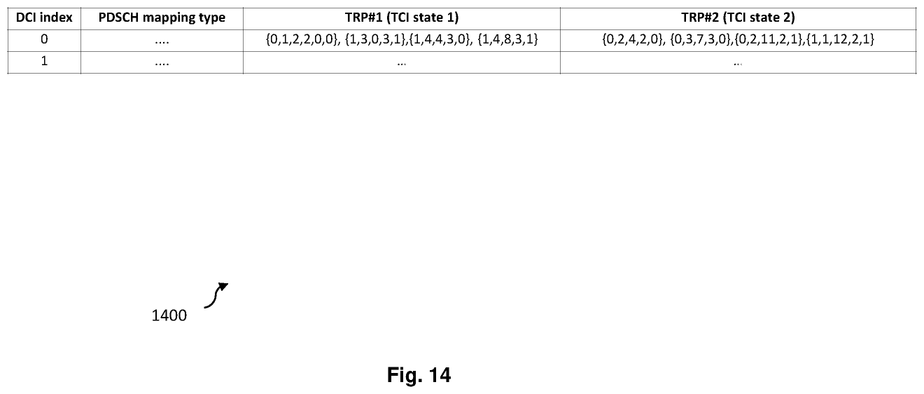

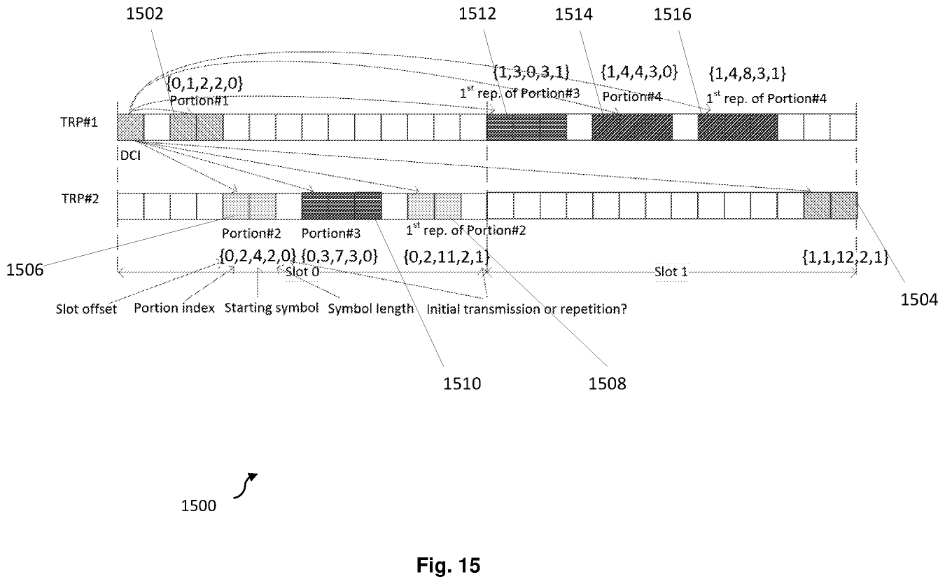

An example of time-domain resource sets of 4 portions for TRP #1 and TRP #2 is shown in table 1400 of FIG. 14 and illustration 1500 of FIG. 15. DCI index 0 of table 1400 is indicated to a UE, and the UE can accordingly derive the time-domain resource sets and associations with TRPs. Referring to table 1400, time-domain resource for each portion assignment is defined as follows. For portion #1 {0,1,2,2,0,0}, the slot offset is 0 slot after the scheduling DCI, portion index is 1, starting symbol is 2 and length is 2 in slot 0. For 1^{st} repetition of portion #1 {1,1,12,2,1}, the slot offset is 1 slot after the scheduling DCI, portion index is 1, starting symbol is 12 and length is 2 in slot 1. For portion #2 {0,2,4,2,0}, the slot offset is 0 slot after the scheduling DCI, portion index is 2, starting symbol is 4 and length is 4 in slot 0. For 1^{st} repetition of portion #2 {0,2,11,2,1}, the slot offset is 0 slot after the scheduling DCI, portion index is 2, starting symbol is 11 and length is 2 in slot 0. For portion #3 {0,3,7,3,0}, the slot offset is 0 slot after the scheduling DCI, portion index is 3, starting symbol is 7 and length is 3 in slot 0. For 1^{st} repetition of portion #3 {1,3,0,3,1}, the slot offset is 1 slot after the scheduling DCI, portion index is 2, starting symbol is 0 and length is 3 in slot 1. For portion #4 {1,4,4,3,0}, the slot offset is 1 slot after the scheduling DCI, portion index is 4, starting symbol is 4 and length is 3 in slot 1. For 1^{st} repetition of portion #4 {1,4,8,3,1}, the slot offset is 1 slot after the scheduling DCI, portion index is 4, starting symbol is 8 and length is 3 in slot 1. In terms of association of each portion to one of the indicated TRPs/Panels as shown in table 1400, portion #1, 1^{st} repetition of portion #3, portion #4, and 1st repetition of portion #4 are transmitted from TRP #1, while portion #2, portion #3, 1^{st} repetition of portion #2, and 1st repetition of portion #1 are transmitted from TRP #2. Further, the actual number of transmissions from TRP #1 and TRP #2 is 4, and their lengths of transmissions are different.

Therefore, referring to FIG. 15, the transmission of portion #1 is shown at 1502, the transmission of 1^{st} repetition of portion #1 is shown at 1504, the transmission of portion #2 is shown at 1506, the transmission of 1^{st} repetition of portion #2 is shown at 1508, the transmission of portion #3 is shown at 1510, the transmission of 1^{st} repetition of portion #3 is shown at 1512, the transmission of portion #4 is shown at 1514 and the transmission of 1^{st} repetition of portion #4 is shown at 1516.

According to an embodiment 3, instead of “a DCI schedules DL radio resource” in embodiment 1 or 2, the scheduling can be done by Semi-Persistent Scheduling (SPS) for DL or configured grant (CG) for UL. Advantageously, using SPS and CG makes DCI-less transmission for periodic traffic.

According to an embodiment 4, instead of using a time domain resource assignment (TDRA) table in embodiment 1 or 2 for the indication of multiple TBs, a frequency-domain resource assignment (FDRA) table can be used. For example, DCI indicates an entry of a FDRA table. In the entry, multiple TBs are defined by a start and a number of PRBs (SN IV) and its association with one of the indicated TCI state. The FDRA table may be configured by a higher layer parameter or specified. The entry of FDRA table can be indicated as a substitution or an addition to frequency domain resource assignment. In some variations, instead of SNIV, bitmap can be used. For example, the bitmap may indicate PRBs or resource block group (RGBs) corresponding to at least a portion and at least one of the indicated TCI states. Instead of an indicated TCI state, a TRP or a panel can be used. A benefit of implementing embodiment 4 is that data rate is increased by scheduling multiple TBs on multiple PDSCH transmissions that have non-overlapping FDRAs with respect to the other PDSCH transmission.

In a variation 4.1 of embodiment 4, at least a different modulation order, code rate, or redundancy version can be applied for each portion from multiple TBs to generate the corresponding PDSCH transmission. In a variation 4.2, instead of a “semi-static configuration of current FDRA or FDRA table based” implementation in Embodiment 4, the frequency-domain resource allocation can be configured by one or a combination of the following:
dynamic configuration of FDRA or FDRA table based;
in addition to FDRA, FDRA table is added as additional assignment; and
each of multiple dynamic FDRA indications for respectively each of multiple TCI states.

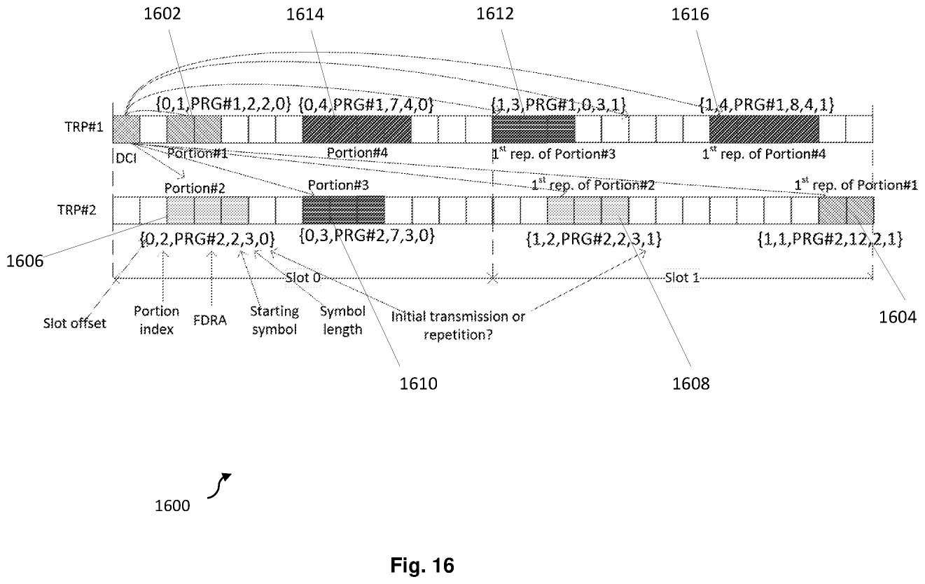

FIG. 16 shows an example illustration 1600 of multi-TB scheduling with repetition for single DCI-based multi-TRP/Panel transmission in FDM scheme in accordance with embodiment 4. For example, it is assumed that a physical resource group (PRG) #1 and a PRG #2 are assigned to TCI state #1 and TCI state #2, respectively. Multiple TBs are segmented into 4 portions with different sizes. Accordingly, FIG. 16 shows an example of time and frequency-domain resource sets for the 4 portions and their own repetitions associated with the corresponding TCI states for the corresponding PDSCH transmission occasions. Portion #1 1602, portion #4 1614, 1^{st} repetition of Portion #3 1612 and 1^{st} repetition of Portion #4 1616 are associated with TCI State #1, while Portion #2 1606, portion #3 1610, 1^{st} repetition of Portion #1 1604 and 1^{st} repetition of Portion #2 1608 are associated with TCI State #2.

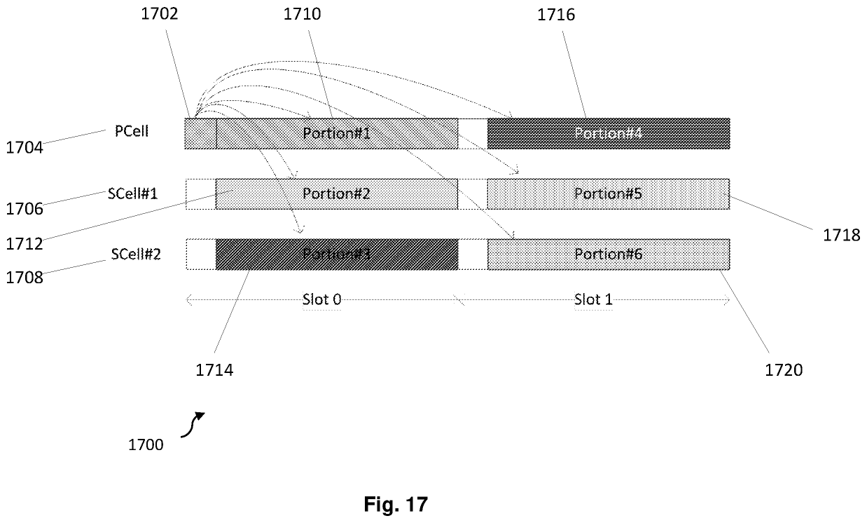

Embodiment 4 can also be applicable for the scenario of cross-carrier scheduling (carrier aggregation) in multiple transmission intervals (slots or mini-slots) as shown in illustration 1700 of FIG. 17. DCI from a primary cell (PCell) is used to schedule multiple TBs for PCell and its secondary cells (SCells). Each of multiple TBs is assigned to one of the serving cells (PCell/PSCell/SCell). FDRA information of each of the plurality of portions is based on the assigned PRBs for the serving cell. For example, there is a PCell 1704 with DCI 1702 and 2 SCells (SCell #1 1706 and SCell #2 1708). Multiple TBs are segmented into 6 TBs (or 6 Portions). In slot 0, DCI 1702 in PCell 1704 is used to schedule Portion #1 1710 for PCell 1704, Portion #2 1712 for SCell #1 1706, and Portion #3 1714 for SCell #2 1708. In slot 1, Portion #4 1716 for PCell 1704, Portion #5 1718 for SCell #1 1706, and Portion #6 1720 for SCell #2 1708 are scheduled by DCI 1702 from slot 0.

In an embodiment 5, code-block-group (CBG)-based feedback is used in embodiments 1 to 4. Each CBG-based feedback in PUCCH or PUSCH corresponds to a CBG of a TB associated with one of the indicated TCI states. A UE generates an acknowledgement (ACK) for the HARQ-ACK information bit of a CBG if the UE correctly received all CBs of the CBG and generates a negative acknowledgement (NACK) for the HARQ-ACK information bit of a CBG if the UE incorrectly received at least one CB of the CBG. In embodiment 5, the number of HARQ-ACK bits is equal to a total number of CBGs from multiple TBs. If multiple TBs are bundled, the number of HARQ-ACK bits is 1. HARQ multiplexing can be applied across CBGs. PUCCH/PUSCH resource indicator (PRI) is provided by the scheduling DCI. Further, the corresponding PUCCH/PUSCH transmission with HARQ feedback (or response signal) could be handled in different ways. In one option, the HARQ feedbacks of the plurality of TBs are multiplexed as a joint HARQ feedback which is sent only on a single PUCCH to the TRP with scheduled DCI such as TRP #1 (TCI state #1). In another option, Respective HARQ feedbacks are sent to the respective TRPs. In another option, the joint HARQ feedback is sent to all TRPs (all TCI states). A benefit of implementing embodiment 5 is that Rel-15/16 related retransmission procedure can be reused. Further, sending the joint HARQ feedback to all TRPs (all TCI states) can improve the robustness of HARQ feedback. Moreover, if the PUCCH/PUSCH transmission with HARQ feedback is collided with one or more other PUCCH/PUSCH transmissions in time domain, an uplink control information (UCI) multiplexing can be used to carry the HARQ feedback on the corresponding PUCCH/PUSCH transmission. A similar approach is also applied to the following embodiments 6 and 7.

In an embodiment 6, TB-based feedback is used in embodiments 1 to 4. Each TB-based feedback in PUCCH/PUSCH corresponds to a TB associated with one of the indicated TCI states, and multiple TBs can have the same HARQ process. For example, a UE generates an ACK for the HARQ-ACK information bit of a TB if the UE correctly received all CBs of the TB and generates a NACK for the HARQ-ACK information bit of a TB if the UE incorrectly received at least one CB of the TB. The number of HARQ-ACK bits is equal to the number of TBs. HARQ multiplexing can be applied across TBs. PUCCH/PUSCH resource indicator is provided by the scheduling DCI. The corresponding PUCCH/PUSCH transmission with HARQ feedback can also be handled in different ways. Advantageously, implementing embodiment 6 can reduce HARQ feedback overhead.

In a variation 6.1 of embodiment 6, when each TB is configured with a different HARQ process, HARQ-related information for each portion (or each TCI state) is independently provided. Such information may include new data indicator (NDI), number of HARQ processes, redundancy version, PUCCH/PUSCH resource allocation for HARQ feedback and other similar information.

In an embodiment 7, TCI state-based feedback is used for embodiments 1 to 4. Each TCI state-based feedback in PUCCH/PUSCH corresponds to a plurality of TBs associated with one of the indicated TCI states. Multiple TCI states have the same HARQ process. For example, a UE generates an ACK for the HARQ-ACK information bit of a TCI state if the UE correctly received all CBs of a plurality of TBs associated with this TCI state and generates a NACK for the HARQ-ACK information bit of a TCI state if the UE incorrectly received at least one CB of the a plurality of TBs associated with this TCI state. The number of HARQ-ACK bits is equal to the number of TCI states. HARQ multiplexing can also be applied across TCI states.

PUCCH/PUSCH resource indicator is provided by the scheduling DCI. Further, the corresponding PUCCH/PUSCH transmission with HARQ feedback could be handled in different ways. Advantageously, compared to CBG-based or TB-based retransmission, TCI-based feedback generates less HARQ feedback overhead and is able to minimize blockage impact on probability rate for requesting retransmission of portions when one of the TCI states (TRPs) is blocked.

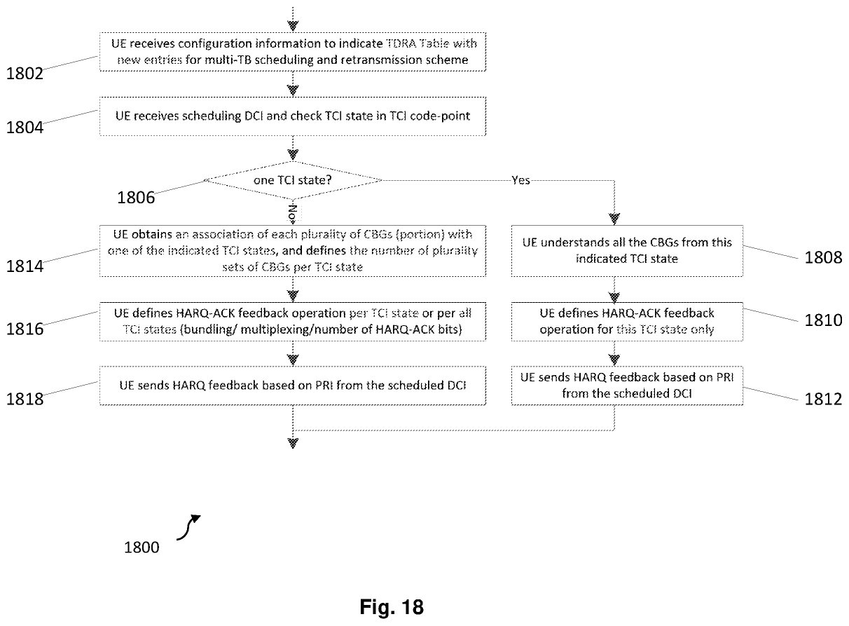

FIG. 18 shows a UE flowchart 1800 for TCI state-based retransmission in accordance with embodiment 7. At step 1802, a UE receives configuration information to indicate TDRA table with new entries for multi-TB scheduling and retransmission scheme. At step 1804, the UE receives scheduling DCI and check TCI state in TCI code-point. At step 1806, it is determined whether there is only one TCI state. If it is determined to be the case, the process proceeds to step 1808 where the UE understands all the CBGs from the indicated TCI state. At step 1810, the UE defines HARQ-ACK feedback operation for this TCI state only. At step 1812, the UE sends HARQ feedback based on PRI from the scheduled DCI. The process then ends. On the other hand, if it is determined at step 1806 that there are more than one TCI states, the process proceeds to step 1814 where the UE obtains an association of each plurality of CBGs (or portions) with one of the indicated TCI states, and defines the number of plurality sets of CBGs per TCI state. At step 1816, the UE defines HARQ-ACK feedback operation per TCI state or per all TCI states (i.e. bundling/multiplexing/number of HARQ-ACK bits). At step 1818 the UE sends HARQ feedback based on PRI from the scheduled DCI. The process then ends.

In embodiments 5, 6, and 7, HARQ-ACK information/feedback bits are included in a HARQ-ACK codebook which is either semi-statically or dynamically configured by gNB. For a semi-statical HARQ-ACK codebook generation, in Rel-15/16, the procedure is briefly summarized as
Step 1: A candidate slot for PDSCH reception is determined by UL slot n and K1 set, and the candidate PDSCH reception occasions are pruned based on TDD configuration and every row r in the TDRA table.
Step 2: HARQ-ACK bits are generated for each candidate PDSCH reception occasion determined in Step 1.
   K1 set is specified in Sub-clause 9.1.2.1 in TS 38.213 depending on for which DCI format a UE is configured to monitor PDCCH. If dl-DataToUL-ACK-r16 is signalled, UE shall ignore the dl-DataToULACK (without suffix). For enhancing the semi-statical HARQ-ACK codebook for multiple PDSCHs scheduled by a DCI, the set of candidate PDSCH reception occasions corresponding to a UL slot with HARQ-ACK transmission is determined based on a set of DL slots and a set of SLIVs corresponding to each DL slot belonging to the set of DL slots as follows
The set of DL slots includes all the unique DL slots that can be scheduled by any row index r of TDRA table in DCI indicating the UL slot as HARQ-ACK feedback timing.
The set of SLIVs corresponding to a DL slot (belonging to the set of DL slots) at least include all the SLIVs that can be scheduled within the DL slot by any row index r of TDRA table in DCI indicating the UL slot as HARQ-ACK feedback timing.
   Based on that, the UE determines a set of occasions for candidate PDSCH receptions or semi-persistent scheduling (SPS) PDSCH releases according to the pseudo-code structure by using a loop while k<C(K₁).

Moreover, for a dynamic HARQ-ACK codebook generation, a counter downlink assignment index (C-DAI) or total downlink assignment index (T-DAI) can be counted per DCI, or per PDSCH, or per a subset of multiple PDSCHs. When C-DAI/T-DAI is counted per DCI, it has a restriction on the number of PDSCHs scheduled by a DCI. In order to have the flexibility on the number of PDSCHs scheduled by a DCI, two separate codebooks can be used for single PDSCH scheduling and multi-PDSCH scheduling by a DCI, respectively. This design allows the mixed operation between single PDSCH scheduling and multi-PDSCH scheduling by a DCI, but it still has the limitation such that the number of PDSCHs in multi-PDSCH scheduling needs to be common. Moreover, the number of PDSCHs in a multi-PDSCH scheduling in a DCI needs to be flexible as the number of PDSCHs can vary depending on the channel conditions and/or the available length of a channel occupancy time (COT). For the dynamic HARQ-ACK codebook generation, the size of the DAI field needs to be increased. In Rel. 15/16 NR, if a DAI field has 2 bits, even when up to 3 consecutive DCIs are missed detection, the HARQ codebook can still be generated correctly. To maintain the same robustness, when multi-PDSCH scheduling is configured, a possible method for determining the DAI field size is shown as follows [R1-2105396]
If only C-DAI is configured, the DAI field size is 2+log 2 N_{Max},
If both T-DAI and C-DAI are configured, the DAI field size is 2×(2+log 2 N_{Max}),
If both T-DAI and C-DAI are configured and non-scheduled PDSCH group is configured, the DAI field size is 3×(2+log 2 N_{Max}).
   Note that N_{Max} is the maximum number of PDSCHs and the non-scheduled PDSCH group as specified in TS 38.212, where gNB can trigger to send HARQ-ACKs for “the non-scheduled PDSCH group” by “Number of requested PDSCH group(s)” field in DCI (with configuring NFI-TotaIDAI-Included-r16=enable by RRC). If “Number of requested PDSCH group(s)”=0, only HARQ-ACKs for “the scheduled PDSCH group” is sent. If “Number of requested PDSCH group(s)”=1, both HARQ-ACKs for “the scheduled PDSCH group” and “the non-scheduled PDSCH group” are concatenated and sent. Furthermore, another method is that the DAI field size for C-DAI/T-DAI is determined based on the number of SLIVs associated with the row indexes in TDRA table which indicates time domain allocation resources for multiple PDSCHs scheduled by the single DCI.

According to agreements from RAN1 #96bis, there are several schemes for multi-TRP-based URLLC, which can be scheduled by a single DCI at least, are clarified as follows:

Scheme 2 (FDM): n (n<=N_{f}) TCI states within the single slot, with non-overlapped frequency resource allocation.
Each non-overlapped frequency resource allocation is associated with one TCI state.
Same single/multiple demodulation reference signal (DMRS) port(s) are associated with all non-overlapped frequency resource allocations.

### Scheme 2a:

A single codeword with one RV is used across full resource allocation. From UE perspective, the common RB mapping (codeword to layer mapping as in Rel-15) is applied across full resource allocation.

### Scheme 2b:

A single codeword with one RV is used for each non-overlapped frequency resource allocation. The RVs corresponding to each non-overlapped frequency resource allocation can be the same or different.
Applying different MCS/modulation orders for different non-overlapped frequency resource allocations can be implemented.
Details of frequency resource allocation mechanism for FDM 2a/2b with regarding to allocation granularity, time domain allocation can be implemented.
   Scheme 3 (TDM): n (n<=Nt1) TCI states within the single slot, with non-overlapped time resource allocation.
Each transmission occasion of the TB has one TCI and one RV with the time granularity of mini-slot.
All transmission occasion (s) within the slot use a common MCS with same single or multiple DMRS port(s).
RV/TCI state can be same or different among transmission occasions.
For further study (FFS): channel estimation interpolation across mini-slots with the same TCI index.
   Scheme 4 (TDM): n (n<=Nt2) TCI states with K (n<=K) different slots
Each transmission occasion of the TB has one TCI and one RV.
All transmission occasion (s) across K slots use a common MCS with same single or multiple DMRS port(s).
RV/TCI state can be same or different among transmission occasions.
FFS: channel estimation interpolation across slots with the same TCI index.

M-TRP/panel based URLLC schemes shall be compared in terms of improved reliability, efficiency, and specification impact. Further, support for number of layers per TRP may be discussed.

According to a technical specification (TS) 38.214 ver. 16.1.0, a UE can be configured by a higher layer parameter such as RepSchemeEnabler set to one of ‘FDMSchemeA’, ‘FDMSchemeB’, ‘TDMSchemeA’, wherein the UE is indicated with two TCI states in a codepoint. When two TCI states are indicated in a DCI and the UE is set to ‘FDMSchemeA’, the UE shall receive a single PDSCH transmission occasion of the TB with each TCI state associated to a non-overlapping frequency domain resource allocation as described in Clause 5.1.2.3. When two TCI states are indicated in a DCI and the UE is set to ‘FDMSchemeB’, the UE shall receive two PDSCH transmission occasions of the same TB with each TCI state associated to a PDSCH transmission occasion which has non-overlapping frequency domain resource allocation with respect to the other PDSCH transmission occasion as described in Clause 5.1.2.3. When two TCI states are indicated in a DCI and the UE is set to ‘TDMSchemeA’, the UE shall receive two PDSCH transmission occasions of the same TB with each TCI state associated to a PDSCH transmission occasion which has non-overlapping time domain resource allocation with respect to the other PDSCH transmission occasion and both PDSCH transmission occasions shall be received within a given slot as described in Clause 5.1.2.1.

For frequency-domain resource allocation under FDMSchemeA and FDMSchemeB, If P′_{BWP.i} is determined as wideband, the first ┌n_{PRB}/2┐ PRBs are assigned to the first TCI state and the remaining ┌n_{PRB}/2┐ PRBs are assigned to the second TCI state, where n_{PRB} is the total number of allocated PRBs for the UE. If P′_{BWP.i} is determined as one of the values among {2, 4}, even PRGs within the allocated frequency domain resources are assigned to the first TCI state and odd PRGs within the allocated frequency domain resources are assigned to the second TCI state.

Embodiments 1˜4 focus on multi-TB scheduling in DL PDSCH. A similar approach can be directly applied for multi-TB scheduling in UL PUSCH by replacing slot offset from K₀_{ₖ} to K₂_{ₖ} for the corresponding kth portion. If only a TRP is activated (TCI state #1 or TCI state #2), the UE sends data transmission to this activated TRP. If multiple TRPs are activated, the UL data transmission is based on the best condition TRP. According to network availability and capability of the UEs, the multiple embodiments can be applied together in a network for both non-RedCap (normal/legacy) UEs and Redcap UEs. It will be appreciated that TRPs can be replaced with panels in the embodiments and examples described herein.

In the embodiments 1-7, the proposed solution and examples discuss a scenario of 2 TRPs, but it will be appreciated that the embodiments are directly applicable to the scenario of more than 2 TRPs. In such a case, more than 2 TCI states are used. This advantageously achieves gain from more TRPs in operation.

Instead of using a single DCI in embodiments 1-4, for multiple DCI-based multi-TRP/panel transmission, each of multiple DCIs can schedule DL radio resource for multiple TBs for each of multiple TRPs or panels. Either joint HARQ feedback or separate HARQ feedback for multiple TBs can be used.

In embodiments 1-4, the proposed solution and examples are applicable to one or more layer transmissions, and are also applicable and beneficial for relatively long round trip time (RTT) scenario, e.g. Non-Terrestrial Networks (NTN), beyond 52.6 GHz. Further, in embodiments 1-4, radio resource of each portion can be indicated in a semi-static manner on the basis of number of TCI states that are semi-statically configured to be indicated by one index of TCI signalling.

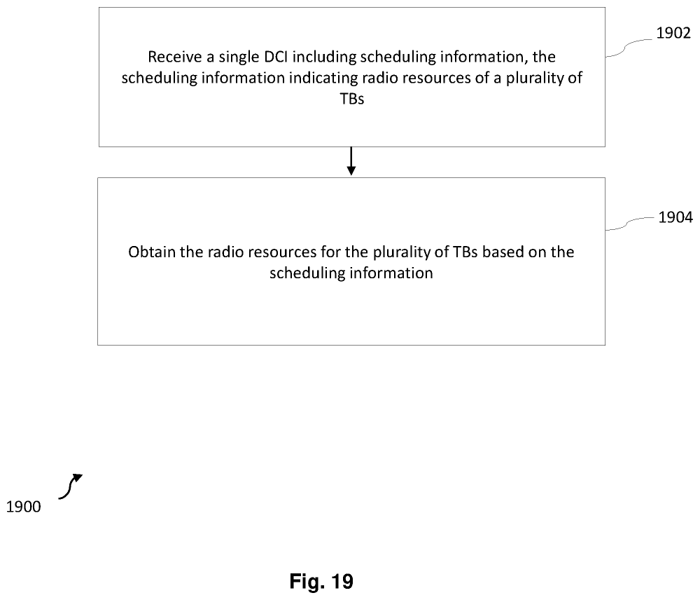

FIG. 19 shows a flow diagram 1900 illustrating a communication method according to various embodiments. In step 1902, a single DCI is received, the single DCI including scheduling information, the scheduling information indicating radio resources of a plurality of TBs. In step 1904, the radio resources for the plurality of TBs are obtained based on the scheduling information.

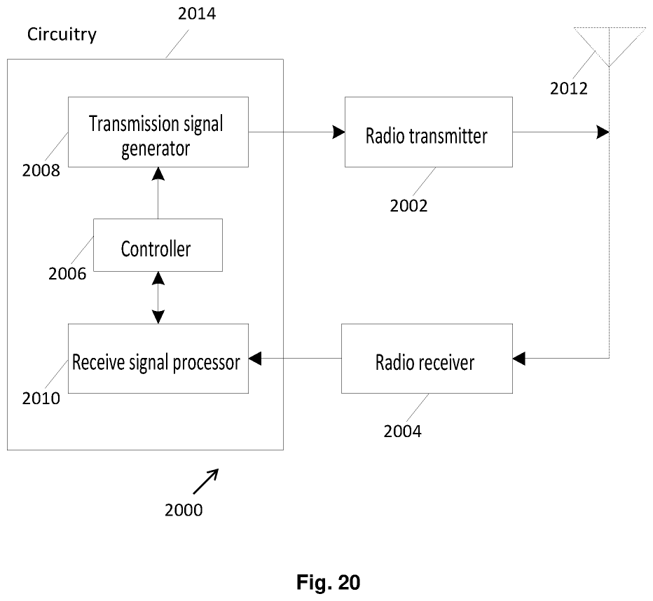

FIG. 20 shows a schematic, partially sectioned view of the communication apparatus 2000 that can be implemented for facilitating implementation of multi-TB scheduling for single DCI-based multi-TRP/Panel transmission in accordance with the various embodiments. The communication apparatus 2000 may be implemented as a base station, gNB or a normal (non-RedCap or Rel-15/16/17) UE, a RedCap UE or other similar types of UE according to various embodiments.

Various functions and operations of the communication apparatus 2000 are arranged into layers in accordance with a hierarchical model. In the model, lower layers report to higher layers and receive instructions therefrom in accordance with 3GPP specifications. For the sake of simplicity, details of the hierarchical model are not discussed in the present disclosure.

As shown in FIG. 20, the communication apparatus 2000 may include circuitry 2014, at least one radio transmitter 2002, at least one radio receiver 2004 and multiple antennas 2012 (for the sake of simplicity, only one antenna is depicted in FIG. 20 for illustration purposes). The circuitry 2014 may include at least one controller 2006 for use in software and hardware aided execution of tasks it is designed to perform, including control of communications with one or more other communication apparatuses in a MIMO wireless network. The at least one controller 2006 may control at least one transmission signal generator 2008 for generating configuration information, HARQ feedback, ACK, NACK, IEs and/or RRC-Reconfig messages to be sent through the at least one radio transmitter 2002 to one or more other communication apparatuses and at least one receive signal processor 2010 for processing said configuration information, HARQ feedback, ACK, NACK, IEs and/or RRC-Reconfig messages received through the at least one radio receiver 2004 from the one or more other communication apparatuses. The at least one transmission signal generator 2008 and the at least one receive signal processor 2010 may be stand-alone modules of the communication apparatus 2000 that communicate with the at least one controller 2006 for the above-mentioned functions, as shown in FIG. 20. Alternatively, the at least one transmission signal generator 2008 and the at least one receive signal processor 2010 may be included in the at least one controller 2006. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 2002, at least one radio receiver 2004, and at least one antenna 2012 may be controlled by the at least one controller 2006.

In the embodiment shown in FIG. 20, the at least one radio receiver 2004, together with the at least one receive signal processor 2010, forms a receiver of the communication apparatus 2000. The receiver of the communication apparatus 2000, when in operation, provides functions required for facilitating implementation of multi-TB scheduling for single DCI-based multi-TRP/Panel transmission.

The communication apparatus 2000, when in operation, provides functions required for facilitating implementation of multi-TB scheduling for single DCI-based multi-TRP/Panel transmission. For example, the communication apparatus 2000 may be a communication apparatus, and the receiver 2004 may, in operation, receive a single DCI including scheduling information, the scheduling information indicating radio resources of a plurality of TBs. The circuitry 2014 may, in operation, obtain the radio resources for the plurality of TBs based on the scheduling information.

The scheduling information may indicate more than one transmission configuration indicator (TCI) states, wherein each of the indicated TCI states corresponds to an activation of one transmission reception point (TRP) or panel, and wherein the radio resources of the plurality of TBs are associated with the indicated TCI states. The scheduling information may indicate one TCI state corresponding to an activation of one TRP or panel, and wherein the radio resources of the plurality of TBs are associated with the indicated TCI state. A first TB of the plurality of TBs relating to a first TRP may be associated with a first TCI state of the indicated TCI states, and a second TB of the plurality of TBs relating to a second TRP may be associated with a second TCI state of the indicated TCI states. Each of the plurality of TBs may be associated with at least one of the indicated TCI states.

The plurality of TBs may be segmented into a plurality of portions, each of the plurality of portions including one or more code-blocks (CBs) or one or more code-block-groups (CBGs) from the plurality of TBs, the scheduling information indicating the radio resources of at least one portion and at least one of the indicated TCI states. The one of the indicated TCI states may be associated with the at least one portion. Each of the plurality of portions may be associated with at least one of the TRPs or panels; and the receiver 2004 may be further configured to receive at least one of the plurality of portions from the TRPs or panels in a downlink transmission using the radio resource. Each of the plurality of portions may be associated with at least one of the TRPs or panels; and wherein the communication apparatus 2000 may further comprise a transmitter 2002, which in operation, transmits at least one of the plurality of portions to the one or more TRPs or panels in an uplink transmission using the radio resource. Each size of the plurality of portions may be configured by a control information such as another DCI, a MAC CE, or an RRC signalling. Each size of the plurality of portions may be determined by a quality of communication link.

The scheduling information may indicate different spatial information for each of the plurality of portions or for each of the one or more TCI states. The scheduling information may configure at least a TCI state with a reference signal (RS) to derive spatial information for at least one of the plurality of portions associated with the configured TCI state. The scheduling information may configure implicitly or explicitly at least a TCI state with a default spatial information for at least one of the plurality of portions associated with the configured TCI state. Each of the plurality of portions may include one or more TBs from the plurality of TBs. Two or more TBs relating to different TRPs in the plurality of TBs may be associated with different portions. Two or more TBs relating to a same TRP in the plurality of TBs may be associated with one portion. The scheduling information may be indicated by semi-persistent scheduling (SPS) for downlink (DL) transmission or configured grant (CG) for uplink (UL) transmission.

The scheduling information may further comprise a time-domain resource assignment (TDRA) table or a frequency-domain resource assignment (FDRA) table, and wherein the radio resources of the plurality of TBs are indicated by the TDRA table or FDRA table. The scheduling information may include a start and length indicator (SLIV) corresponding to the at least one portion and at least one of the indicated TCI states. The scheduling information may include a start symbol and an allocation length corresponding to the at least one portion and at least one of the indicated TCI states. The scheduling information may include a slot offset corresponding to the at least one portion and at least one of the indicated TCI states. The scheduling information may include a start physical resource block (PRB) and a number of PRBs corresponding to the at least one portion and at least one of the indicated TCI states. The scheduling information may include FDRA corresponding to the at least one portion and at least one of the indicated TCI states. The scheduling information may include a bitmap indicating PRBs or resource block group (RGBs) corresponding to the at least a portion and at least one of the indicated TCI states. The scheduling information may include one or a combination of a portion index, a redundancy version (RV), a mapping type, a modulation order, a code rate and an interleaving pattern. The TDRA table or the FDRA table may be configured by at least a DCI, MAC CE, or RRC signalling. The TDRA table or the FDRA table may be specified in the specifications.

The scheduling information may indicate the radio resources of at least one portion from the plurality of TBs and at least one of the indicated TCI states for an initial transmission, and may also indicate the radio resources of at least a repetition of the at least one portion and at least one of the indicated TCI states for a repetition transmission. An association of a portion with one of the indicated TCI states for the initial transmission may be either same or different from that for the repetition transmission. The scheduling information may further indicate the radio resources of at least one portion and at least one of the serving cells (PCell, PSCell, or SCell) for an initial transmission, and may also indicate the radio resources of at least a repetition of the at least one portion and at least one of the serving cells (PCell, PSCell, or SCell) for a repetition transmission. Spatial information of one portion from the plurality of TBs for initial transmission may be either same or different from that for the retransmission. The single DCI may be scheduled to be transmitted from one of plurality of TRP or panels. The scheduling information may further indicate initial transmissions of the plurality of portions from the plurality of TBs for a single TRP configured with the single DCI, named as a primary TRP, while repetition transmissions of portions from the plurality of TBs may be configured for the remaining TRPs other than the primary TRP. An interleaving pattern may be applied for contents of all the portions and their own repetitions, and wherein the interleaving pattern is indicated implicitly by a pre-configured rule or explicitly by at least DCI, MACE or RRC signalling.

The circuitry 2014 may be further configured to generate a response signal for each of the CBGs. An acknowledgement (ACK) signal may be generated if the receiver 2004 correctly received all CBs of a CBG, and a negative acknowledgement (NACK) signal may be generated if the receiver 2004 incorrectly received at least one CB of the CBG. The circuitry 2014 may be further configured to generate a response signal for each of the plurality of portions. An ACK signal may be generated if the receiver 2004 correctly received all CBs of a portion, and generate a NACK signal if the receiver 2004 incorrectly received at least one CB of the portion. The circuitry may be further configured to generate a response signal for each of the indicated TCI states. An ACK signal may be generated if the receiver 2004 correctly received all CBs related to a TCI state, and a NACK signal may be generated if the receiver 2004 incorrectly received at least one CB related the TCI state. The scheduling information may indicate PUCCH or PUSCH resource indicator (PRI) for the response signal; and wherein the communication apparatus 2000 may further comprise a transmitter 2002, which in operation, transmits the response signals of the plurality of TBs on a corresponding PUCCH or PUSCH based on the scheduling information. The scheduling information may indicate to multiplex the response signals of the plurality of TBs as a joint HARQ signal; and wherein the transmitter 2002 may be further configured to transmit the joint HARQ signal to a TRP configured with the single DCI. The transmitter may be further configured to transmit independent response signals of the plurality of TBs to their corresponding TRPs, respectively. The transmitter 2002 may be further configured to transmit the joint HARQ signal of the plurality of TBs to all the TRPs. The scheduling information may further indicate independent HARQ-related information per portion or per TCI state

The communication apparatus 2000, when in operation, provides functions required for facilitating implementation of multi-TB scheduling for single DCI-based multi-TRP/Panel transmission. For example, the communication apparatus 2000 may be a base station or gNB, and the circuitry 2014 may, in operation, generate a single DCI including scheduling information, the scheduling information to indicate radio resources of a plurality of TBs; and the transmitter 2002 may, in operation, transmit the single DCI to a communication apparatus.

As described above, the embodiments of the present disclosure provides advanced communication methods and communication apparatuses that enable implementation of multi-TB scheduling for Single DCI-based Multi-TRP/Panel transmission.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (I)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. A communication apparatus comprising:
a receiver, which in operation, receives a single downlink control information (DCI) including scheduling information, the scheduling information indicating radio resources of a plurality of transport blocks (TBs); and
circuitry, which in operation, obtains the radio resources of the plurality of TBs based on the scheduling information.

2. The communication apparatus according to claim 1, wherein the scheduling information indicates more than one transmission configuration indicator (TCI) states, wherein each of the indicated TCI states corresponds to an activation of one transmission and reception point (TRP) or panel, and wherein the radio resources of the plurality of TBs are associated with the indicated TCI states.

3. The communication apparatus according to claim 1, wherein the scheduling information indicates one TCI state corresponding to an activation of one TRP or panel, and wherein the radio resources of the plurality of TBs are associated with the indicated TCI state.

4. The communication apparatus according to claim 2, wherein each of the plurality of TBs is associated with at least one of the indicated TCI states.

5. The communication apparatus according to claim 2, wherein the plurality of TBs are segmented into a plurality of portions, each of the plurality of portions including one or more code-blocks (CBs) or one or more code-block-groups (CBGs) from the plurality of TBs, the scheduling information indicating the radio resources of at least one portion and at least one of the indicated TCI states.

6. The communication apparatus according to claim 5, wherein each of the plurality of portions includes one or more TBs from the plurality of TBs.

7. The communication apparatus according to claim 5, wherein the scheduling information further comprises a time-domain resource assignment (TDRA) table or a frequency-domain resource assignment (FDRA) table, and wherein the radio resources of the plurality of TBs are indicated by the TDRA table or FDRA table.

8. The communication apparatus according to claim 7, wherein the scheduling information includes a start and length indicator (SLIV) corresponding to the at least one portion and at least one of the indicated TCI states.

9. The communication apparatus according to claim 7, wherein the TDRA table or the FDRA table is configured by at least a DCI, MAC CE, or RRC signalling.

10. The communication apparatus according to claim 5, wherein the circuitry is further configured to generate a response signal for each of the plurality of portions.

11. The communication apparatus according to claim 10, wherein an ACK signal is generated if the receiver correctly received all CBs of a portion, and generate a NACK signal if the receiver incorrectly received at least one CB of the portion.

12. The communication apparatus according to claim 11, wherein the scheduling information indicates PUCCH or PUSCH resource indicator (PRI) for the response signal; and wherein the communication apparatus further comprises a transmitter, which in operation, transmits the response signals of the plurality of TBs on a corresponding PUCCH or PUSCH based on the scheduling information.

13. The communication apparatus according to claim 12, wherein the scheduling information indicates to multiplex the response signals of the plurality of TBs as a joint HARQ signal; and wherein the transmitter is further configured to transmit the joint HARQ signal to a TRP configured with the single DCI.

14. A base station comprising:
circuitry, which in operation, generates a single DCI including scheduling information, the scheduling information indicating radio resources of a plurality of transport blocks (TBs); and
a transmitter, which in operation, transmits the single DCI to a communication apparatus.

15. A communication method comprising:
receiving a single DCI including scheduling information, the scheduling information indicating radio resources of a plurality of TBs; and
obtaining the radio resources for the plurality of TBs based on the scheduling information.
